(19) United States
(12) Patent Application Publication
(10) Pub. No.: US 2018/0345682 A1
(43) Pub. Date: Dec. 6, 2018

(54) PRINTER AND METHOD FOR OPERATING A PRINTER

(71) Applicant: Océ Holding B.V., Venlo (NL)

(72) Inventors: Wilhelmus J.E.G. VERHOFSTAD, Venlo (NL); Cornelis P.M. VAN HEIJST, Venlo (NL)

(73) Assignee: Océ Holding B.V., Venlo (NL)

(21) Appl. No.: 15/959,923

(22) Filed: Apr. 23, 2018

(30) Foreign Application Priority Data
May 30, 2017 (EP) 17173474.2

(51) Int. Cl. B41J 11/00; B41M 7/00; B41J 3/407; B41M 5/00

(52) U.S. Cl. CPC B41J 11/002; B41M 7/0081; B41M 5/0047; B41J 3/407; B41M 5/0064; B41J 11/009

(57) ABSTRACT

In a method for applying an image onto a recording medium, a print can be created that has a gloss similar to the gloss of the recording medium. The method includes selecting a recording medium; determining the gloss level of the selected medium; selecting curing settings based on the determined gloss level; applying an image onto the recording medium by ejecting a predetermined pattern of droplets of ink onto the recording medium; and curing the ink according to the selected curing settings, thereby obtaining a cured image having the determined gloss level. A printer is configured for applying an image onto a recording medium according to the method.

### CROSS-REFERENCE TO RELATED APPLICATIONS

This application claims priority under 35 U.S.C. § 119(a) to Application No. 17173474.2, filed in Europe on May 30, 2017, the entire contents of which is hereby incorporated by reference into the present application.

### BACKGROUND OF THE INVENTION

### 1. Field of the Invention

The present invention relates to a method for applying an image onto a recording medium. The invention also relates to a printer configured for applying an image onto a recording medium in accordance with the method.

### 2. Description of Background Art

Ink jet printers are known in the background art. Ink jet printers apply an image onto a recording medium by applying a predetermined pattern of droplets onto the recording medium. The droplets are generally ejected by one or more print heads. When applying an image onto the recording medium, it is desired that the visual appearance of the resulting print is good. One aspect of the visual appearance of the print is the gloss of the print. It is desired to have an even gloss level on the print. In other words, it is desired that the gloss level of different parts of the print, both parts covered with ink and parts not covered with ink, is about the same. However, the gloss level of an ink layer provided on the recording medium may differ from the gloss level of the recording medium itself. As a result, parts of the medium covered with ink may have a different gloss level than parts of the recording medium not covered with ink. This is undesirable.

It is known to circumvent this problem by covering the entire recording medium with ink. In such cases, parts of the recording medium that would not require application of a colorant to form the desired image, are covered with ink, for example a colorless ink such as an overcoat or varnish, or a color that matches the color of the recording medium, such as white ink. However, such solution requires applying an additional type of ink, e.g. varnish, overcoat, white ink, and may require the presence of an additional print head. This may increase the cost, including the running cost of the printer. This is also undesirable.

It is therefore an object of the present invention to provide a method for forming a printed image that has an even gloss level, while limiting the required number of ink compositions and/or print heads needed. It is a further object of the present invention to provide a printer configured for performing such method.

### SUMMARY OF THE INVENTION

The object of the present invention is achieved in a method for applying an image onto a recording medium, the method comprising the steps of selecting a recording medium; determining the gloss level of the selected recording medium; selecting curing settings based on the determined gloss level; applying an image onto the recording medium by ejecting a predetermined pattern of droplets of ink onto the recording medium; and curing the ink according to the selected curing settings, thereby obtaining a cured image having the determined gloss level.

In the method according to the invention, a recording medium is selected. The medium may be selected from a list of media. The list of media may be stored on a storage device and may be retrieved by a user, for example via the interface of a controller of the printer, or via a computer that is in communication with the printer. Alternatively, the medium may be manually selected by an operator and inserted into the printer. The recording medium, on which the image is formed, has a certain gloss level. The recording medium may be a matt medium. Such recording medium may have a low gloss. The recording medium may be a glossy medium, i.e. the recording medium may have a high gloss. Further, the recording medium may be a semi-gloss medium. The gloss of the medium may be determined by the properties of the medium, such as, but not limited to surface morphology, porosity, material, presence and nature of coatings.

In the method according to the present invention, the gloss level of the selected medium is determined. The gloss level of the selected medium may be retrieved from values stored in a look up table. Alternatively, the gloss may be measured and the measured value may be input to a computing device in communication with the printer. Measuring the gloss may be done inline (in the printer machine) or offline.

In the method according to the present invention, curing settings are selected based on the determined gloss level. As the gloss level is determined from the selected medium, the selected curing settings may depend on the selected medium. When applying an ink onto a recording medium, the ink may be cured after printing. Curing may increase the robustness of the ink layer and/or may increase the adhesion of the ink layer to the recording medium. Application of ink may alter the gloss level of a surface. Thus, the gloss level of a recording medium covered with ink may differ from the gloss level of the recording medium. Further, curing may alter the gloss level of the ink layer positioned on a surface of the recording medium. The way in which the ink is cured may also influence the gloss level of the ink layer. Therefore, in the method according to the present invention, the curing settings are selected. The curing settings may comprise a desired power output level of the curing device. The curing device may comprise sources of radiation, for example lamps. The radiation emitted by the sources of radiation may be electromagnetic radiation, such as IR radiation or UV radiation. Alternatively and/or additionally, the curing device may comprise heated curing devices, such as heated rollers or heated surfaces. The curing settings may further comprise a time interval between applying ink onto the recording medium and curing the ink.

The curing settings may be selected such that the gloss level of the ink layer provided on the recording medium is in the same range as the gloss level of the recording medium. In this way, there may be little or no visible difference in gloss between parts of the recording medium covered with ink and parts of the recording medium not covered with ink. The difference in gloss between parts of the recording medium covered with ink and parts of the recording medium not covered with ink may be 30 gloss units (GU) or less, preferably 20 GU or less, more preferably 10 GU or less. Ideally, the gloss level of parts of the recording medium covered with ink and parts of the recording medium not covered with ink is the same.

One of the possible curing settings selected in the method according to the present invention is not applying any curing to the ink.

In the method according to the present invention, an image is applied onto the recording medium by ejecting a predetermined pattern of droplets of ink onto the recording medium. The droplets may be applied using an ink jet print head. Examples of print heads are piezo-electric print heads or thermal print heads. One having ordinary skill in the art will understand how to apply an image onto the recording medium by ejecting a predetermined pattern of droplets of ink onto the recording medium.

In the method according to the present invention, the ink is cured according to the selected curing settings, thereby obtaining a cured image having the determined gloss level. By curing the ink, the ink layer may be fixed onto the recording medium and an ink surface may be formed on the recording medium. By curing the ink according to the selected curing settings, the ink surface may be fixed. By fixing the ink, the morphology of the ink surface may be fixed, and the ink surface may have a gloss level similar to the gloss level of the recording medium. In the context of the present invention, the “cured image having the determined gloss level” is to be interpreted as a cured image that has a gloss level that deviates at most 30 gloss units (GU) or less from the gloss level of the recording medium not covered with ink. Ideally, the gloss level of parts of the recording medium covered with ink and parts of the recording medium not covered with ink is the same.

Prints having an even gloss level over the surface of the recording medium, including parts covered with ink and parts not covered with ink may be obtained using the method according to the present invention. No change in ink composition is necessary for printing on different types of recording medium having a different gloss level.

In an embodiment, the ink is a radiation-curable ink. Radiation-curable inks are inks that can be cured under influence of radiation, preferably electro-magnetic radiation, such as UV radiation. Radiation-curable inks may comprise radiation-curable components that undergo a polymerization reaction under influence of radiation, such as (meth)acrylates, vinylethers and epoxides. An ink composition comprising radiation-curable components may be fluid in the uncured state; i.e. a state in which the ink is not yet cured. The ink may be in the fluid state when it is jetted onto the recording medium. It may still be fluid after it has been jetted on the recording medium. The fluid ink may flow on the recording medium. The more the ink droplets flow, the more even the surface of the ink layer formed may be. The more even the surface of the ink layer, the higher the gloss level of the ink surface may be. Flow of the radiation-curable ink may be decreased by irradiating the ink with a suitable source of radiation, thereby increasing the viscosity of the ink. The stronger the increase in viscosity, the more the flow of the ink is restricted. The faster the increase in viscosity, the more the flow is restricted. The strength and/or timing of the viscosity increase of the ink may be influenced by suitably selected the intensity of the radiation applied of the ink on the recording medium and/or the time interval between jetting the ink and irradiating the ink.

In a further embodiment, the ink is a UV gelling ink. A UV gelling ink is a UV-radiation curable ink; i.e. an ink that can be cured upon irradiation with UV radiation. The UV gelling ink may further have gelling properties. The ink may be fluid at elevated temperatures and may be in a gelled (semi-solid) state at lower temperatures. A UV gelling ink may be jetted at elevated temperatures. The ink may cool down upon application on the recording medium. Cooling down of the ink may induce an increase in viscosity and may turn the ink from a fluid state into a gelled state. In the gelled state, the ink may flow to some extent, but may not flow too much, thereby preventing print artefacts such as color bleed. When using a UV gelling ink, the flow of the ink may be more accurately controlled compared to a non-gelling UV ink. Therefore, the structure of the ink surface may be accurately controlled when using a UV gelling ink and hence, the gloss level of the ink layer may be accurately controlled.

In an embodiment, part of the recording medium is not covered with ink. When forming an image onto a recording medium, it may not be necessary to cover the entire surface of the recording medium. Some parts of the recording medium may not be covered with ink. For example, the borders of the recording medium may not be covered with ink. Further, parts of the image to be printed may have a color that matches the color of the recording medium. On these parts, no ink needs to be applied and these parts may therefore not be covered with ink. The method according to the present invention allows matching of the gloss level of the ink layer applied to the gloss level of the recording medium. This can be achieved for different ink compositions and different types of recording medium. It may not be necessary to match the ink composition to the recording medium for obtaining an even gloss level.

In an embodiment, curing is done by irradiating the ink with a source of radiation. Irradiation with a suitable source of radiation may be a suitable way to cure an ink composition. For example, IR radiation may heat an ink composition and thereby cure the ink. Another example of a suitable source of radiation may be a source of electron beam radiation or UV radiation. UV radiation may be suitably applied to cure UV curable ink. Examples of UV radiation sources are UV lamps, such as UV LED lamps and Hg bulbs. UV LEDs are preferred, because they are energy efficient and because the intensity of the radiation emitted by UV LEDs can be easily adjusted.

In a further embodiment, the curing settings comprise a power output level of a source of radiation. The higher the power output level of a source of radiation, the more energy may be applied to the ink and the faster the ink may cure. The power output level of a source of radiation may be varied from a maximum power output of the radiation source to a zero output level of a radiation source. The power output level may correspond to the intensity of the radiation emitted by the source of radiation.

In an embodiment, the curing settings comprise a time interval between ejection of the droplet of ink and curing of the ink.

The longer the time interval between ejection of the droplet of ink and curing of the ink, the more the ink may flow before the droplets are immobilized by curing. The recording medium may move in a paper transport direction in between jetting of the droplet and curing of the ink. In such case, the timing may be adjusted by adjusting the distance between the jetting device, such as the print head, and the curing unit. Alternatively and/or additionally, a plurality of curing units may be positioned at different distances from the jetting device in the paper transport direction. By switching the individual curing units on or off, the timing between ejection of the droplet of ink and curing of the ink may be selected.

In an embodiment, curing settings are selected for a first curing unit and a second curing unit. The first curing unit and the second curing unit may both be configured to cure the ink applied onto the recording medium. Both the first curing unit and the second curing unit may comprise a source of radiation, such as a source of UV radiation. Different curing settings may be selected for the first curing unit and the second curing unit. For example, one of the first and second curing units may be turned off. Alternatively, both the first and second curing unit may emit radiation. The relative intensity of the radiation emitted by the first curing unit and the second curing unit may be suitably selected. The relative position of the first curing unit with regard to a print head may be different from the relative position of the second curing unit with regard to the print head. The relative position of the curing unit with regard to the print head may influence the time interval between printing and curing. Thus, by selecting curing settings for two distinct curing units, the time interval between printing and curing may be determined.

In an aspect of the invention, a printer comprises a droplet ejection unit; a curing unit; and a control unit configured to control the curing unit to cure the ink in accordance with the method of the present invention.

The printer may comprise a droplet ejection unit. The droplet ejection unit may be, e.g. a print head. Examples of print heads are piezo-electric print heads and thermal print heads. The printer may further comprise a curing unit. The curing unit may comprise one or more lamps, such as UV LED lamps. The printer may further comprise a control unit. The control unit may be in communication with the droplet ejection unit and the print head. The control unit may be configured to control the curing unit to cure the ink according to the method of the present invention. The printer may thus be configured to perform the method of the present invention.

In an embodiment, the printer comprises a first curing unit and a second curing unit, wherein the control unit is configured to control the first curing unit and the second curing unit in accordance with an embodiment of the present invention. The printer may thus be configured to perform the method according to an embodiment of the present invention.

Further scope of applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1A is a schematic representation of an inkjet printing system;

FIG. 1B is a schematic representation of an inkjet print head;

FIG. 1C is a schematic representation of an image forming apparatus;

FIG. 2 is a flow diagram of a method according to the present invention;

FIG. 3 schematically shows a first example according to the present invention;

FIG. 4 schematically shows a second example according to the present invention;

FIG. 5 schematically shows a method of applying an image onto the recording medium by ejecting a predetermined pattern of droplets of ink onto the recording medium and curing the image in accordance with a third example of the present invention;

FIG. 6 schematically shows a method of applying an image onto the recording medium by ejecting a predetermined pattern of droplets of ink onto the recording medium and curing the image in accordance with a fourth example of the present invention;

FIG. 7 schematically shows a method of applying an image onto the recording medium by ejecting a predetermined pattern of droplets of ink onto the recording medium and curing the image in accordance with a fifth example of the present invention;

FIG. 8 shows the relation between the coverage of a recording medium and the gloss for a first comparison experiment; and

FIG. 9 shows the relation between the coverage of a recording medium and the gloss for a second comparison experiment.

### DETAILED DESCRIPTION OF THE PREFERRED EMBODIMENTS

The present invention will now be described with reference to the accompanying drawings, wherein the same reference numerals have been used to identify the same or similar elements throughout the several views.

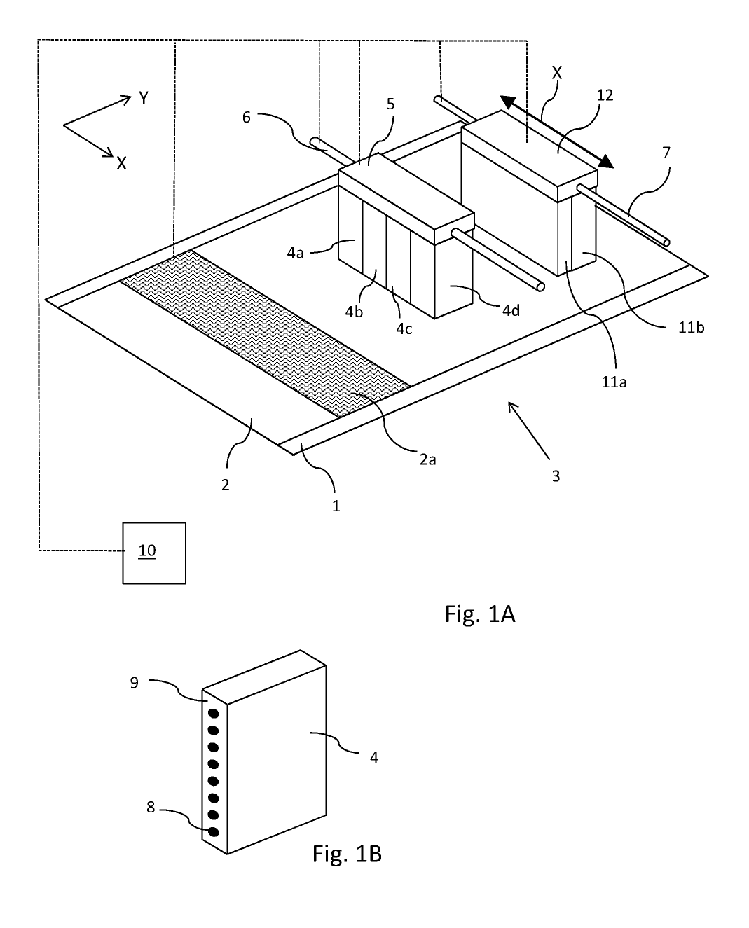

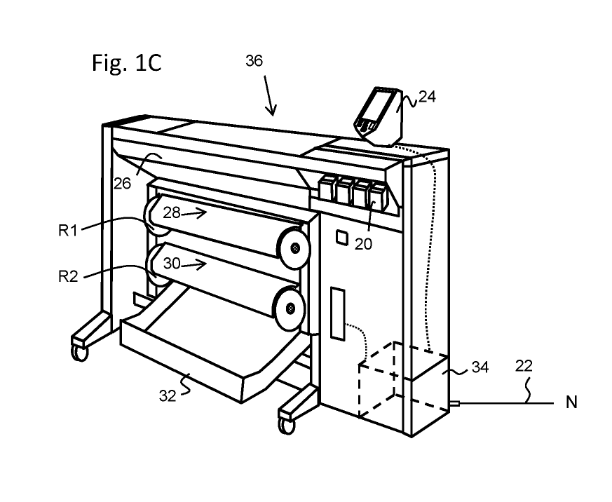

FIG. 1A shows an ink jet printing assembly 3. The ink jet printing assembly 3 comprises a support for supporting an image receiving medium 2. The support is shown in FIG. 1A as a flat surface 1, but alternatively, the support may be a platen, for example a rotatable drum that is rotatable around an axis. The support may be optionally provided with suction holes for holding the image receiving medium in a fixed position with respect to the support. The ink jet printing assembly 3 comprises print heads 4a-4d mounted on a scanning print carriage 5. The scanning print carriage 5 is guided by a suitable guide 6 to move in reciprocation in the main scanning direction X. Each print head 4a-4d comprises an orifice surface 9 provided with at least one orifice 8, as is shown in FIG. 1B. The print heads 4a-4d are configured to eject droplets of marking material onto the image receiving medium 2.

The image receiving medium 2 may be a medium in web or in sheet form and may be composed of, e.g. paper, cardboard, label stock, coated paper, plastic or textile. Alternatively, the image receiving medium 2 may also be an intermediate member, endless or not. Examples of endless members, which may be moved cyclically, are a belt or a drum. The image receiving medium 2 is moved in the sub-scanning direction Y over the flat surface 1 along four print heads 4a-4d provided with a fluid marking material.

The image receiving medium 2, as depicted in FIG. 1A, is locally heated or cooled in the temperature control region 2a. In the temperature control region 2A, a temperature controller (not shown), such as a heater and/or a cooling device may be provided to control the temperature of the receiving medium 2. Optionally, the temperature controller may be integrated in the support for supporting an image receiving medium 2. The temperature controller may be an electrical temperature controller. The temperature controller may use a cooling and/or heating liquid to control the temperature of the image receiving medium 2. The temperature controller may further comprise a sensor (not shown) for monitoring the temperature of the image receiving medium 2.

A scanning print carriage 5 carries the four print heads 4a-4d and may be moved in reciprocation in the main scanning direction X parallel to the platen 1, such as to enable scanning of the image receiving medium 2 in the main scanning direction X. Only four print heads 4a-4d are depicted for demonstrating the invention. In practice, an arbitrary number of print heads may be employed. In any case, at least one print head 4a-4d per color of marking material is placed on the scanning print carriage 5. For example, for a black-and-white printer, at least one print head 4a-4d, usually containing black marking material is present. Alternatively, a black-and-white printer may comprise a white marking material, which is to be applied on a black image-receiving medium 2. For a full-color printer, containing multiple colors, at least one print head 4a-4d for each of the colors, usually black, cyan, magenta and yellow is present. Often, in a full-color printer, black marking material is used more frequently in comparison to differently colored marking material. Therefore, more print heads 4a-4d containing black marking material may be provided on the scanning print carriage 5 compared to print heads 4a-4d containing marking material in any of the other colors. Alternatively, the print head 4a-4d containing black marking material may be larger than any of the print heads 4a-4d, containing a differently colored marking material.

The carriage 5 is guided by a guide 6. The guide 6 may be a rod as depicted in FIG. 1A. Although only one rod 6 is depicted in FIG. 1A, a plurality of rods may be used to guide the carriage 5 carrying the print heads 4. The rod may be driven by a suitable drive (not shown). Alternatively, the carriage 5 may be guided by another type of guide, such as an arm being able to move the carriage 5. Another alternative is to move the image receiving material 2 in the main scanning direction X.

Each print head 4a-4d comprises an orifice surface 9 having at least one orifice 8, in fluid communication with a pressure chamber containing fluid marking material provided in the print head 4a-4d. On the orifice surface 9, a number of orifices 8 are arranged in a single linear array parallel to the sub-scanning direction Y, as is shown in FIG. 1B. Alternatively, the nozzles may be arranged in the main scanning direction X. Eight orifices 8 per print head 4a-4d are depicted in FIG. 1B, however, in a practical embodiment several hundreds of orifices 8 may be provided per print head 4a-4d, optionally arranged in multiple arrays.

As depicted in FIG. 1A, the respective print heads 4a-4d are placed parallel to each other. The print heads 4a-4d may be placed such that corresponding orifices 8 of the respective print heads 4a-4d are positioned in-line in the main scanning direction X. This means that a line of image dots in the main scanning direction X may be formed by selectively activating up to four orifices 8, each of them being part of a different print head 4a-4d. This parallel positioning of the print heads 4a-4d with corresponding in-line placement of the orifices 8 is advantageous to increase productivity and/or improve print quality. Alternatively multiple print heads 4a-4d may be placed on the print carriage adjacent to each other such that the orifices 8 of the respective print heads 4a-4d are positioned in a staggered configuration instead of in-line. For instance, this may be done to increase the print resolution or to enlarge the effective print area, which may be addressed in a single scan in the main scanning direction X. The image dots are formed by ejecting droplets of marking material from the orifices 8.

The ink jet printing assembly 3 may further comprise a curing device 11a, 11b. As shown in FIG. 1A, a scanning print carriage 12 carries the two curing devices 11a, 11b and may be moved in reciprocation in the main scanning direction X parallel to the platen 1, such as to enable scanning of the image receiving medium 2 in the main scanning direction X. Alternatively, more than two curing devices may be utilized. The first curing device 11a may emit a first beam of UV radiation, the first beam having a first intensity. The first curing device 11a may be configured to provide the radiation for the pre-curing step. The second curing device 11b may emit a second beam of radiation, the second beam of radiation having a second intensity. The second curing device 11b may be configured to provide the radiation for the post-curing step.

The carriage 12 is guided by a guide 7. The guide 7 may be a rod as depicted in FIG. 1A. Although only one rod 7 is depicted in FIG. 1A, a plurality of rods may be used to guide the carriage 12 carrying the print heads 11. The rod 7 may be driven by a suitable drive (not shown). Alternatively, the carriage 12 may be guided by another type of guide, such as an arm being able to move the carriage 12.

The curing devices 11a and 11b may be energy sources, such as actinic radiation sources, accelerated particle sources or heaters. Examples of actinic radiation sources are UV radiation sources or visible light sources. UV radiation sources are preferred, because they are particularly suited to cure UV curable inks by inducing a polymerization reaction in such inks. Examples of suitable sources of such radiation are lamps, such as mercury lamps, xenon lamps, carbon arc lamps, tungsten filaments lamps, light emitting diodes (LED's) and lasers. In the embodiment shown in FIG. 1A, the first curing device 11a and the second curing device 11b are positioned parallel to one another in the sub scanning direction Y. The first curing device 11a and the second curing device 11b may have the same type of energy source or may have a different type of energy source. For example, when the first and second curing devices 11a, 11b, respectively both emit actinic radiation, the wavelength of the radiated emitted by the two respective curing devices 11a, 11 b may differ or may be the same. The first and second curing devices are depicted as distinct devices. However, alternatively, only one source of UV radiation emitting a spectrum of radiation may be used, together with at least two distinct filters. Each filter may absorb a part of the spectrum, thereby providing two beams of radiation, each one having intensity different from the other and/or a radiation spectrum different from the other.

The flat surface 1, the temperature controller, the carriage 5, the print heads 4a-4d, the carriage 12 and the first and second curing devices 11a, 11b are controlled by a suitable controller 10.

FIG. 1C shows an image forming apparatus 36, wherein printing is achieved using a wide format inkjet printer. The wide-format image forming apparatus 36 comprises a housing 26, wherein the printing assembly, for example the ink jet printing assembly shown in FIG. 1B, is placed. The image forming apparatus 36 also comprises a storage area for storing image receiving member 28, 30, a delivery station to collect the image receiving member 28, 30 after printing and storage for marking material 20. In FIG. 1A, the delivery station is embodied as a delivery tray 32. Optionally, the delivery station may comprise a processing device for processing the image receiving member 28, 30 after printing, e.g. a folder or a puncher. The wide-format image forming apparatus 36 further comprises a mechanism for receiving print jobs and optionally a mechanism for manipulating print jobs. These mechanisms may include a user interface unit 24 and/or a control unit 34, for example a computer.

Images are printed on an image receiving member, for example paper, supplied by a roll 28, 30. The roll 28 is supported on the roll support R1, while the roll 30 is supported on the roll support R2. The roll 28 may be a different type of media than roll 30. Alternatively, cut sheet image receiving members may be used instead of rolls 28, 30 of image receiving members. Printed sheets of the image receiving member, cut off from the roll 28, 30, are deposited in the delivery tray 32.

Each one of the marking materials for use in the printing assembly are stored in four containers 20 arranged in fluid connection with the respective print heads for supplying marking material to said print heads.

The local user interface unit 24 is integrated to the print engine and may comprise a display unit and a control panel. Alternatively, the control panel may be integrated in the display unit, for example in the form of a touch-screen control panel. The local user interface unit 24 is connected to a control unit 34 placed inside the printing apparatus 36. The control unit 34, for example a computer, comprises a processor adapted to issue commands to the print engine, for example for controlling the print process. The image forming apparatus 36 may optionally be connected to a network N. The connection to the network N is diagrammatically shown in the form of a cable 22, but nevertheless, the connection could be wireless. The image forming apparatus 36 may receive printing jobs via the network. Further, optionally, the controller of the printer may be provided with a USB port, so printing jobs may be sent to the printer via this USB port.

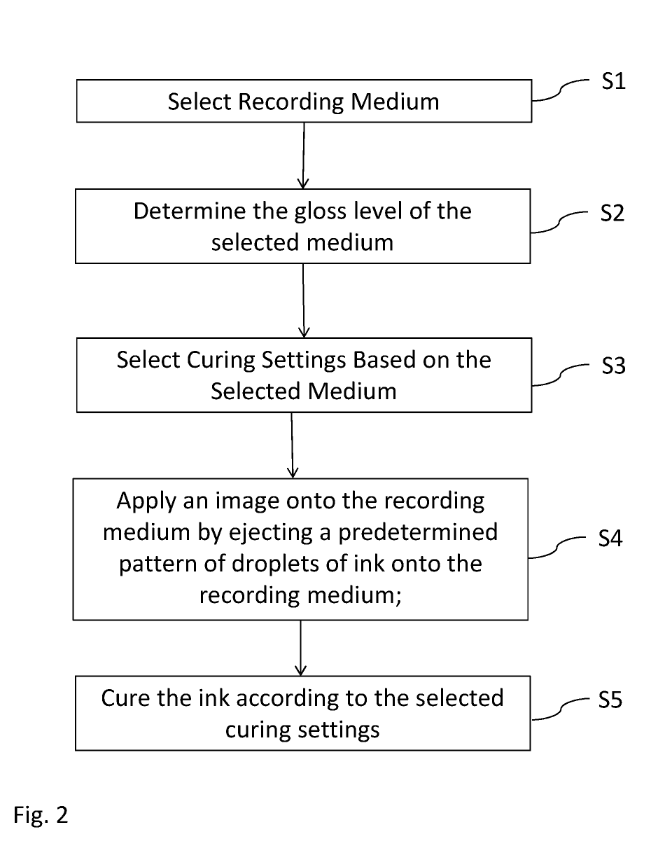

FIG. 2 is a flow diagram of a method according to the present invention. The flow diagram shows 5 steps: S1-S5, which can be performed consecutively.

In step S1, a recording medium is selected. The medium may be selected from a list of media. The list of media may be stored on a storage device and may be retrieved by a user, for example via the interface of a controller of the printer, or via a computer that is in communication with the printer. Alternatively, the medium may be manually selected by an operator and inserted into the printer. The recording medium, on which the image is formed, has a certain gloss level.

In step S2, the gloss level of the selected medium is determined. The gloss level of the selected medium may be retrieved from values stored in a look up table. Alternatively, the gloss may be measured and the measured value may be input to computing means in communication with the printer.

In Step S3, curing settings are selected based on the selected medium. The curing settings may be selected such, that the gloss level of the ink layer provided on the recording medium is in the same range as the gloss level of the recording medium. In this way, there may be little or no visible difference in gloss between parts of the recording medium covered with ink and parts of the recording medium not covered with ink.

In Step S4, an image is applied onto the recording medium by ejecting a predetermined pattern of droplets of ink onto the recording medium.

In Step S5, the ink is cured according to the selected curing settings. By curing the ink, the ink layer may be fixed onto the recording medium and an ink surface may be formed on the recording medium. By curing the ink according to the selected curing settings, the ink surface may be fixed. By fixing the ink, the morphology of the ink surface may be fixed, and the ink surface may have a gloss level similar to the gloss level of the recording medium.

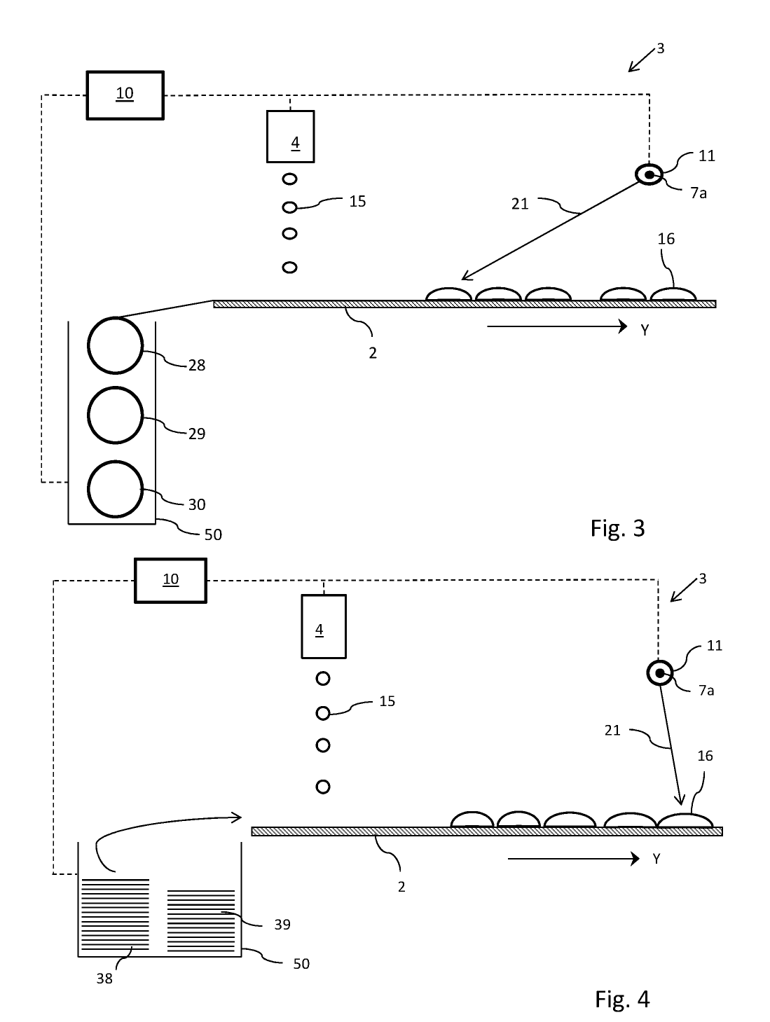

FIG. 3 schematically shows a first example according to the present invention. A paper input module 50 is provided. The paper input module 50 comprises three media rolls 28, 29, 30. Each one of the three media rolls 28, 29, 30 comprises a different type of media. The paper input module 50 is operatively connected to control unit 10. The control unit 10 controls the media that is fed into the printer 3. In the example shown in FIG. 3, media is supplied from roll 28. The type of media can be selected by an operator via a user interface of the printer (not shown). Alternatively, the type of media can be selected when defining a print job at a computer that is in operative connection with control unit 10.

A print head 4 is configured to jet droplets 15 of ink onto a receiving medium 2. Only one print head 4 is depicted in FIG. 3, but in practice, a plurality of print heads may be provided, optionally jetting different colors of ink. Each one of the droplets 15, when jetted by the print head, is in the fluid state. To bring and keep the ink in the fluid state, the print head may be provided with a heater (not shown). The ink may start cooling down after is has been ejected from the print head 4 through a nozzle (not shown). The receiving medium 2 onto which droplets 15 of the ink are applied is moved in direction Y, which is the paper transport direction. If a scanning ink jet process is used, for example the one shown in FIG. 1A, the paper transport direction is often referred to as a main scanning direction. A source of UV radiation 11 is provided. The source of radiation 11 is a page wide source of radiation, which is rotatable around an axis 7b. The source of radiation 11 emits a beam of radiation, schematically depicted as rays of radiation 21. By rotating the source of radiation 11, the position on the recording medium 2 where the rays of radiation irradiate the recording medium can be adjusted. The droplets are cured by the rays 21 of the radiation emitted by the source of radiation 11, resulting in a cured ink layer 16. The print head 4 and the source of radiation 11 are in operative communication with control unit 10.

In the example shown in FIG. 3, the droplets of ink 15 applied onto the recording medium 2 are cured relatively soon after the ink has been applied onto the recording medium. After curing, the droplets do not spread any further onto the recording medium and the gloss of the image may be fixed.

FIG. 4 schematically shows a second example according to the present invention. A paper input module 50 is provided. The paper input module 50 comprises two media 38, 39. Each one of the two media 38, 39 comprises a different type of media. The paper input module 50 is operatively connected to control unit 10. The control unit 10 controls the media that is fed into the printer 3. In the example shown in FIG. 4, media is supplied from first pile of media 38. The type of media can be selected by an operator via a user interface of the printer (not shown). Alternatively, the type of media can be selected when defining a print job at a computer that is in operative connection with control unit 10. The control unit is also in operative communication with print head 4 and source of radiation 11.

The method shown in FIG. 4 is similar to the method shown in FIG. 3. However, in the situation shown in FIG. 4, the source of radiation 11 is rotated compared to the situation shown in FIG. 3. Therefore, the radiation 21 irradiates a different part of the recording medium 2 compared to the situation shown in FIG. 3. In addition, the distance between the position where the ink droplets 15 are applied onto the recording medium 2 and the position where the ink applied onto the recording medium is irradiated by the source of radiation 11 is larger compared to the situation shown in FIG. 3. Thus, at a similar speed of paper transport in direction Y, the time interval between application of the ink droplets 15 onto the recording medium 2 and irradiating the ink droplets, thereby obtaining cured ink, is longer in the situation shown in FIG. 4, compared to the situation shown in FIG. 3.

The ink droplets stay uncured for a period of time after being applied onto the recording medium 2. This allows the droplets of ink to spread on the medium. The spreading of ink droplets on the recording medium may influence the gloss of the print.

The example shown in FIG. 4 can be suitably used with a UV ink, preferably a UV gelling ink. A UV gelling ink may be in the fluid phase when droplets of the ink are ejected onto the recording medium 2. The UV gelling ink may cool down on the recording medium 2. As a result of the cooling of the ink, the viscosity of the ink may increase, which may limit the mobility of the droplets on the recording medium 2.

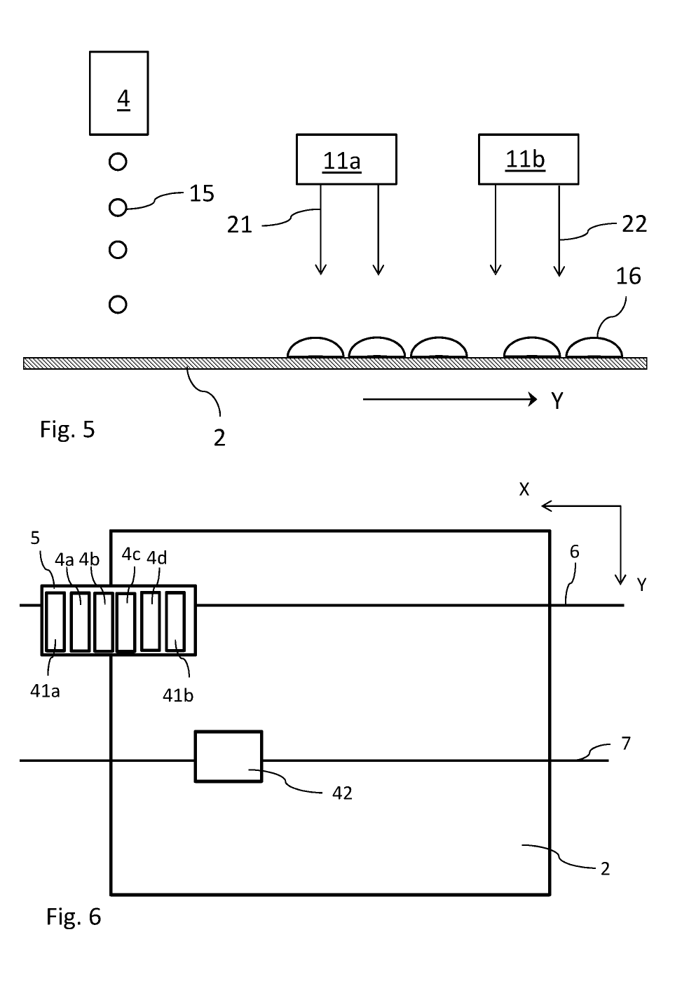

FIG. 5 schematically shows a method of applying an image onto the recording medium 2 by ejecting a predetermined pattern of ink droplets 15 onto the recording medium and curing the image in accordance with a third example of the present invention.

In FIG. 5, a first source of radiation 11a and a second source of radiation 11b are shown. The first source of radiation emits a first beam of radiation 21; the second source of radiation emits a second beam of radiation 22. The first source of radiation 11a is positioned upstream of the second source of radiation 11b in the direction Y.

Thereby, the ink droplets are moved underneath the first source of UV radiation 11a. The ink droplets may be droplets of a UV ink in the gelled phase. The radiation emitted by the first source 11a may have a first intensity. The droplets are pre-cured by the rays 21 of the radiation emitted by the first source of radiation 11a. The intensity of the radiation is selected such that the temperature of the droplets does not exceed the gelling temperature. Therefore, the droplets stay in the immobilized state. By pre-curing the droplets, the droplets 16 are partially cured and may thereby become immobilized. After undergoing the pre-curing, there may be a certain time interval before the droplets are post-cured. Since the droplets 16 are immobilized, this should not negatively influence the quality of the image formed.

After the immobilized droplets 16 have been pre-cured, the droplets are moved underneath a second source of UV radiation 11b. The radiation emitted by the second source 11b may have a second intensity. The immobilized droplets are post-cured by the rays 22 of the radiation emitted by the second source of radiation 11b. Upon post-curing the droplets 16, the droplets may be fixed onto the receiving medium and may not change shape any more, even if they are heated to a temperature above the gelling temperature.

In the situation shown in FIG. 5, both the first source of radiation 11a and the second source of radiation 11b emit radiation. However, in an alternative embodiment, one of the sources of radiation 11a, 11b may be switched off.

FIG. 6 schematically shows a method of applying an image onto the recording medium by ejecting a predetermined pattern of droplets of ink onto the recording medium and curing the image in accordance with a fourth example of the present invention. FIG. 6 is a schematic top view of a printing system. The printing system comprises a print head carriage 5. The print head carriage 5 carries four print heads 4a, 4b, 4c, 4d and a first curing unit 41a, 41b. When printing, the print head carriage moves in reciprocation in direction X. The first curing unit comprises two sources of radiation, 41a and 41b. When switched on, the first curing unit 41a, 41b may irradiate droplets of ink immediately after they have been jetted onto the recording medium 2 by any of the print heads 4a, 4b, 4c, 4d. The intensity of the radiation emitted by the first curing unit 41a, 41b may be suitably controlled by a control unit (not shown). The intensity of the radiation emitted by the first curing unit 41a, 41b may be such, that the ink is completely cured upon irradiation by the first curing unit. In that case, the second curing unit 42 may be switched off. In an alternative embodiment, the first curing unit 41a, 41b may be switched off. In a further alternative embodiment, the intensity of the radiation emitted by the first source of radiation 41 is such that partial curing of the ink on the recording medium 2 may occur. When the print head carriage 5 moves to the right, the ink applied may be irradiated by the source of radiation 41a positioned on the left of the print head carriage 5. When the print head carriage 5 moves to the right the source of radiation 41b positioned on the right of the print head carriage 5 may be switched off.

When the print head carriage 5 moves to the left, the ink applied may be irradiated by the source of radiation 41b positioned on the right of the print head carriage 5. When the print head carriage 5 moves to the left the source of radiation 41a positioned on the left of the print head carriage 5 may be switched off.

The printing system further comprises a second curing unit 42. The second curing unit 42 is positioned downstream of the first curing unit 41 in the paper transport direction Y. The second curing unit is configured to move in reciprocation in scanning direction X. The second curing unit is guided by guide rail 7. When switched on, the second curing unit 42 may irradiate ink applied onto the recording medium 2. The intensity of the radiation emitted by the second curing unit 42 may be suitably controlled by a control unit (not shown).

By suitably controlling the intensity of radiation emitted by the first curing unit 41a, 41b and the second curing unit 42, respectively, the gloss of the ink layer applied onto the recording medium 2 can be suitably controlled.

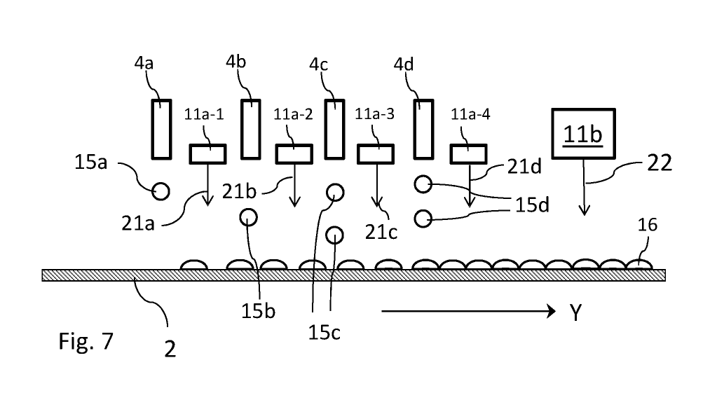

FIG. 7 schematically shows a method of applying an image onto the recording medium by ejecting a predetermined pattern of droplets of ink onto the recording medium and curing the image in accordance with a fifth example of the present invention. FIG. 7 is a schematic side view of a printing system. The printing system comprises four page wide print heads arrays 4a, 4b, 4c, 4d. Downstream of each print head, a first source of radiation 11a-1, 11a-2, 11a-3, 11a-4 is provided. Each one of the first sources of radiation emit a first beam of radiation 21a, 21b, 21c, 21d. Downstream of the print heads 4 and downstream of the first sources of radiation 11a-1, 11a-2, 11a-3, 11a-4, a second source of radiation 11b is provided, which emits a second beam of radiation 22. Each one of the print heads may eject a different color of ink. For example, the print heads may eject cyan, magenta, yellow and black ink. In an alternative embodiment, even more print heads may be provided to increase the number of different ink and coating compositions that can be applied onto the recording medium 2. Each one of the first sources of radiation 11a-1, 11a-2, 11a-3, 11a-4 may emit the same radiation. Alternatively, the radiation of the first sources of radiation 11a-1, 11a-2, 11a-3, 11a-4 may be adapted to the type of ink ejected by the print head directly upstream of the source of radiation. For example, the radiation spectrum may be selected such that there is compensation for different adsorption spectra by the different colorants present in the ink ejected by the individual print heads 4a, 4b, 4c, 4d. During the printing operation, the recording medium 2 is moved in paper transport direction Y.

Thereby, the ink droplets applied by the print heads 4 are moved underneath the first sources of UV radiation 11a-1, 11a-2, 11a-3, 11a-4. The ink droplets may be droplets of a UV ink in the gelled phase. The radiation emitted by the first sources 11a-1, 11a-2, 11a-3, 11a-4 may have a first intensity. The droplets are pre-cured by the rays 21a, 21b, 21c, 21d of the radiation emitted by the first sources of radiation 11a-1, 11a-2, 11a-3, 11a-4. The intensity of the radiation is selected such that the temperature of the droplets does not exceed the gelling temperature. Therefore, the droplets stay in the immobilized state. By pre-curing the droplets, the droplets are partially cured and may thereby become immobilized. After undergoing the pre-curing, there may be a certain time interval before the droplets are post-cured. Since the droplets are immobilized, this should not negatively influence the quality of the image formed.

After the immobilized droplets have been pre-cured, the droplets are moved underneath a second source of UV radiation 11b. The radiation emitted by the second source 11b may have a second intensity. The immobilized droplets are post-cured by the rays 22 of the radiation emitted by the second source of radiation 11b. Upon post-curing the droplets 16, the droplets may be fixed onto the receiving medium and may not change shape any more, even if they are heated to a temperature above the gelling temperature.

In the situation shown in FIG. 7, the first sources of radiation 11a-1, 11a-2, 11a-3, 11a-4 and the second source of radiation 11b emit radiation. However, in an alternative embodiment, each one of the sources of radiation 11a-1, 11a-2, 11a-3, 11a-4, 11b may be individually controlled.

### Experiments and Examples

### Materials

MPI 2000, a white polymeric self-adhesive vinyl film from Avery Dennison and MPI 2020, a matte white calendered vinyl film from Avery Dennison were used as the recording medium.

### Methods

### Gloss

The gloss of an image was measured after the ink was cured. The gloss was measured using a micro-TRI glossmeter obtained from BYK-Gardner GmbH using the internal calibration and measurement method. The micro-TRI gloss measuring device simultaneously measures the gloss under an angle of 20°, 60° and 85°, respectively. The gloss level reported is the gloss level measured under an angle of 60°.

### Printing

Prints were made using an Océ Colorado 1640 printer. The printer was modified; a Phoseon FE300 LED lamp (wavelength 395 nm; emitting window size 75 mm×10 mm) was mounted on the print head carriage, such that the lamp was positioned parallel to the print heads in the paper transport direction and downstream of the print heads in the scanning direction, and was positioned 5 mm above the surface of the recording medium. Prints were made in the Specialty mode, wherein the print mode was adapted to be mono directional (10 m²/h) at a resolution of 600*1800 dpi and a droplet size of 11 pl. Only cyan ink was used. Prints were thus made in mono-directional print mode; the print direction was such that the Phoseon FE300 LED lamp was positioned downstream of the prints head in the scanning direction when printing.

In the printing experiments, the coverage of the recording medium was varied from 0% to 100%. 0% coverage refers to a medium to which no ink is applied. 100% coverage refers to a recording medium to which 11 pl sized droplets have been applied at a resolution of 600*1800 dpi.

### Curing

Two different curing strategies were applied: Direct Cure and After Cure.

When applying the Direct Cure curing strategy, the Phoseon FE 300 LED lamp mounted on the print head carriage was turned on. The lamps mounted on the carriage positioned downstream of the print head carriage in the paper transport direction, where operated at 48% of their maximum power.

When applying After Cure, the Phoseon FE 300 LED lamp mounted on the print head carriage was turned off, whereas the lamps mounted on the carriage positioned downstream of the print head carriage in the paper transport direction, where operated at 51% of their maximum power.

### Example and Comparative Example

| | | Gloss of | | Gloss of cured |
|---|---|---|---|---|
| | Recording | recording | Curing | print @ 90% |
| Experiment | medium | medium | Strategy | coverage |
| Ex 1 | MPI 2000 | 90 | After Cure | 85 |
| CE 1 | MPI 2000 | 90 | Direct Cure | 12 |
| Ex 2 | MPI 2020 | 10 | Direct Cure | 7 |
| CE 2 | MPI 2020 | 10 | After Cure | 85 |

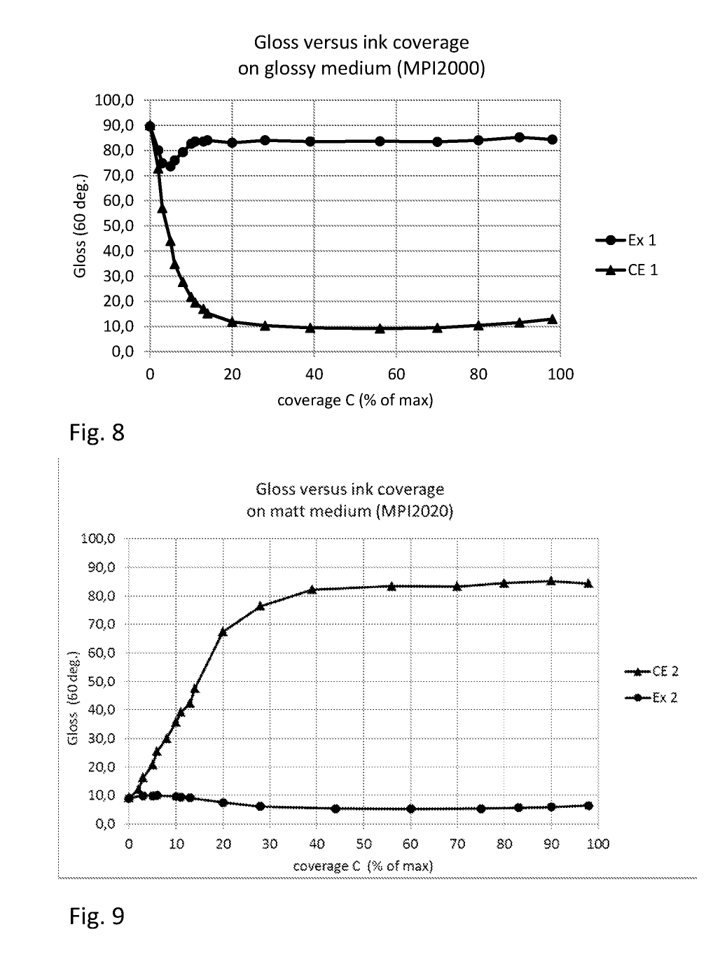

FIG. 8 shows the relation between the coverage of a recording medium and the gloss for a first comparison experiment. In this comparison experiment, prints were made using MPI 2000 as a recording medium. This recording medium is a glossy medium, it has a gloss of 90 gloss units when measured according to the method described above. Two different experiments are depicted in FIG. 8; example 1 (Ex 1) and comparative example 1 (CE 1).

The first example (Ex 1) is a print example that was performed by applying After Cure. At 0% coverage, the gloss of the print equals the gloss of the recording medium, which is 90. When applying ink, the gloss slightly decreases. At about 5% coverage, the curve shows a minimum. When further increasing the coverage, the gloss increases and reaches a value of about 85% at 11% coverage. When further increasing the coverage, the gloss hardly changes. Thus, by applying After Cure curing strategy in combination with the glossy medium MPI 2000, the gloss of the print has only a minor deviation (about 5 gloss units) from the gloss of the medium. This difference in gloss is hardly visible to the human eye.

The first Comparative example (CE 1) is a print example that was performed by applying Direct Cure. When applying ink onto the recording, the gloss of the print strongly decreases as the coverage increases to about 20%. At 20%, the gloss of the print is about 12 gloss units, which is well below the gloss of the recording medium. When further increasing the coverage, only little changes in the gloss are observed. Thus, by applying Direct Cure in combination with the glossy medium MPI 2000, the gloss of the print strongly deviates (about 78 gloss units) from the gloss of the medium. This difference is clearly visible to the human eye.

FIG. 9 shows the relation between the coverage of a recording medium and the gloss for a second comparison experiment. In this comparison experiment, prints were made using MPI 2020 as a recording medium. This recording medium is a matte medium; it has a gloss of 10 gloss units when measured according to the method described above. Two different experiments are depicted in FIG. 9; example 2 (Ex 2) and comparative example 2 (CE 2).

The second example (Ex 2) is a print example that was performed by applying Direct Cure. At 0% coverage, the gloss of the print equals the gloss of the recording medium, which is 10. When applying ink, the gloss slightly decreased. At about 30% coverage, the gloss is about 6 gloss units. A slight increase is observed when further increasing the coverage. When further increasing the coverage, the gloss increases and reaches a value of about 7% at 90% coverage. Thus, by applying Direct Cure curing strategy in combination with the matte medium MPI 2020, the gloss of the print has only a minor deviation (about 3 gloss units) from the gloss of the medium. This difference in gloss is hardly visible to the human eye.

The second Comparative example (CE 2) is a print example that was performed by applying After Cure. When applying ink onto the recording, the gloss of the print strongly increases as the coverage increases to about 40%. At 40%, the gloss of the print is above 80 gloss units, which is well above the gloss of the recording medium. When further increasing the coverage, only little changes in the gloss are observed. Thus, by applying After Cure in combination with the matte medium MPI 2020, the gloss of the print strongly deviates (about 75 gloss units) from the gloss of the medium. This difference is clearly visible to the human eye.

In summary, the above comparison experiments show that a print can be obtained having a gloss that is similar to the gloss of the recording medium by selecting a suitable curing strategy, based on the gloss of the recording medium.

The present invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for applying an image onto a recording medium, the method comprising the steps of:
selecting a recording medium;
determining the gloss level of the selected recording medium;
selecting curing settings based on the determined gloss level;
applying an image onto the recording medium by ejecting a predetermined pattern of droplets of ink onto the recording medium; and
curing the ink according to the selected curing settings, thereby obtaining a cured image having the determined gloss level.

2. The method according to claim 1, wherein the ink is a radiation-curable ink.

3. The method according to claim 2, wherein the ink is a UV gelling ink.

4. The method according to claim 1, wherein in said step of applying an image onto the recording medium, part of the recording medium is not covered with ink.

5. The method according to claim 1, wherein said step of curing further comprises the step of irradiating the ink with a source of radiation.

6. The method according to claim 5, wherein the curing settings comprise a power output level of a source of radiation.

7. The method according to claim 5, wherein the curing settings comprise a time interval between ejection of the droplet of ink and curing of the ink.

8. The method according to claim 1, wherein said step of selecting curing settings further comprises the steps of selecting curing settings for a first curing unit and selecting curing settings for a second curing unit.

9. A printer comprising:
a droplet ejection unit;
a curing unit; and
a control unit,
wherein said control unit is configured to control the curing unit to cure the ink by:
selecting a recording medium;
determining the gloss level of the selected recording medium;
selecting curing settings based on the determined gloss level;
applying an image onto the recording medium by ejecting a predetermined pattern of droplets of ink onto the recording medium with the droplet ejection unit; and
curing the ink according to the selected curing settings with the curing unit, thereby obtaining a cured image having the determined gloss level.

10. The printer according to claim 9, further comprising:
a first curing unit; and
a second curing unit,
wherein the control unit is configured to control the first curing unit and the second curing unit by selecting curing settings for the first curing unit and selecting curing settings for the second curing unit.
